(19) United States
(12) Patent Application Publication
(10) Pub. No.: US 2006/0288835 A1
(43) Pub. Date: Dec. 28, 2006

(54) Table saw fence push guide

(76) Inventor: Wayne Jacob Gregoire, Eden Prairie, MN (US)

Correspondence Address: Wayne J. Gregoire, 12771 Gordon Drive, Eden Prairie, MN, 55346, US

(21) Appl. No.: 11/166,544

(22) Filed: Jun. 24, 2005

(51) Int. Cl. B23D 15/00

(52) U.S. Cl. 83/436.2

(57) ABSTRACT

A push guide device (10), comprised of a dual base glide arrangement of base plate guide (14) and table plate guide (32), handle (22), and vertical guide plate (16) for precision processing of stock material (54) on a table saw (56). A machine operator can load stock material (54) onto a table saw (56) and hold the stock material (54) by means of the push guide device (10). The operator moves the push guide device (10) along a fence slot (62) at the top of a table saw fence (60) while engaging the vertical guide plate (16) continuously with the stock material (54) at notch (64). Comprised of dual pivot rods (38) and pivot springs (40), the operator makes adjustment to the pivot rods (38) by forward pressure to move and secure the stock material (54).

### BACKGROUND OF THE INVENTION

The present invention relates generally to the Cutting of narrow pieces of wood plastic, metal and other materials on a table saw. Pieces such as this are used in cabinet manufacturing and other product manufacturing processes. The use of hand feeding pieces through a table saw or the use of power feeders is representative of the prior art existing in this field of cabinet processing. Hand processing is dependent on operator skill. Power feeders are generally to cumbersome for managing narrow pieces of material. The need for short pieces of material is an example of a circumstance that can occur. The prior art and methods of processing materials do not solve the problem of cutting short narrow pieces of material with accuracy, safety, speed and consistent results.

From the above, it can be seen what is needed is a table saw fence push guide with a greater degree of operator ease, less operator skill, safety, more economical and consistent results, on a table saw.

### OBJECTIVES

The primary object of this invention is the precision cutting and feeding of wood and other stock material and to provide a holding and pushing apparatus for precision processing of material on a table saw.

A more specific object of the present invention is to universally adapt to already existing table saw fences.

Another object of the present invention is the ability to deliver a portable system of material holding and handling to existing table saws.

Another object of the present invention is to control stability of the work piece while it is being processed.

Another object of the present invention is to deliver a work piece to the machine blade with controlled precision.

Another object of the present invention is to provide solidarity to hand held options for the work piece.

Another object of the present invention is to provide rigidity in positioning and holding options for the work piece.

Another object of the present invention is to provide a more stable means to cut the work piece.

Another object of the present invention is to receive a higher degree of safety for the machine operator.

Another object of the present invention is to provide improved visibility of the process for the machine operator.

Another object of the present invention is to produce precision consistent results, efficient use of the operator's time or reduce operator stress. Kick back, potential for injury, is reduced.

Another object of the present invention is the elimination of waste and improved performance of the machine on which it is used.

Another object of the present invention is to accommodate normal cutting and precession processing of stock materials in the form of short pieces.

Another object of the invention is to keep the operator's hands away from the cutting blade, when cutting.

Another object of the invention is to allow operator's view of cut in progress.

Another object of the invention is to modify the use of a table saw fence.

### SUMMARY OF THE INVENTION

The present invention is a holding device for precision processing of wood and material on a table saw. Typically this power tool is used in wood working shops by professionals and amateurs. This tool is used to process other materials as well. As a result of the use of this holding device, material processing precision and operating conditions are greatly improved.

In the preferred embodiment, the assembly features a portable dual base glide system universally adaptable to various types of table saw fences. The present invention, which is operator controlled, allows for loading and precision placement of a work piece in a controlled and rigid holding environment. The machine operator is then able to move the work piece through the cutting operation in a positively engaged way with high visibility and with a greater degree of operator safety. The assembly features a dual base glide arrangement, handle, vertical guide plate and compatibility with other manufacturers equipment.

### BRIEF DESCRIPTION OF THE DRAWINGS

In order that the invention may be dearly understood and readily carried into effect, a preferred embodiment of the invention will now be described, by way of example only, with reference to the accompanying drawings wherein:

All Figures are drawn for ease of explanation of the basic teachings of the present invention only. The extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

Where used in the various figures of the drawings, the same numerals designate the same or similar parts. Furthermore, when the terms “forward”, and “vertical”, and similar terms are used herein, it should be understood that these terms have reference only to the structure shown in the drawings as it would appear to a person viewing the drawings and are utilized only to facilitate describing the preferred embodiments.

FIG. 1 is a perspective view of the push guide in rest position on a table saw.

FIG. 2 is a perspective view of the push guide, in use, in the forward cutting position on a table saw.

FIG. 3 is a side view of the forward end of the push guide.

FIG. 4 is a plan view of the push guide.

### DETAILED DESCRIPTION OF THE INVENTION

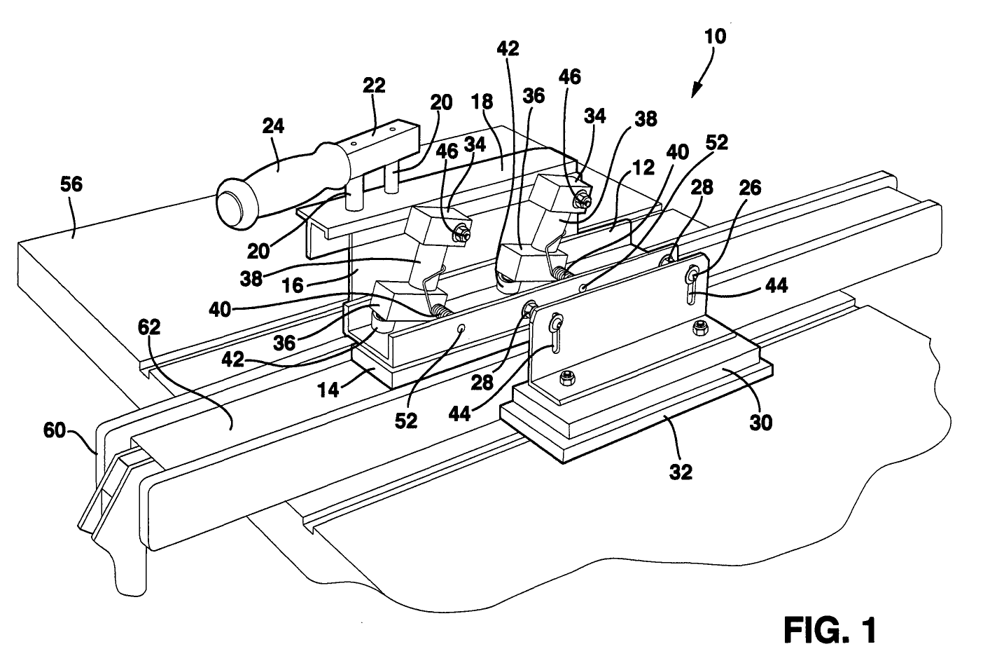

FIG. 1 is a perspective view of the push guide device 10 at rest on a table saw 56. The push guide device 10 is engaged in the fence slot 62 at the top of the table saw fence 60. The guide 10 has a dual base plate configuration. It is comprised of a base plate glide 14 and a table plate glide 32. The plates 14 and 32 are made from 0.50 and 0.75 UHMW polyethylene plate, respectively. The plate 14 is attached to a channel 12 with three channel adjustment slots 48. The preferred material for channel 12 is 6061 aluminum. Three channel adjustment bolts 50 connect plate 14 to the channel 12. This arrangement gives adjustment universality to table saw and fence dimensional considerations. The plate 32 is in contact with ballast bar 30 composed of A36 carbon steel. The importance of the use of this material is because of its weight factor. Ballast bar 30 is connected to side angle 26. Angle 26 has two adjustment slots 44. Side bolts 28 attach through slots 44 and are connected to channel 12 by a double nutted attachment. This arrangement gives adjustment universality to table saw and fence dimensional considerations.

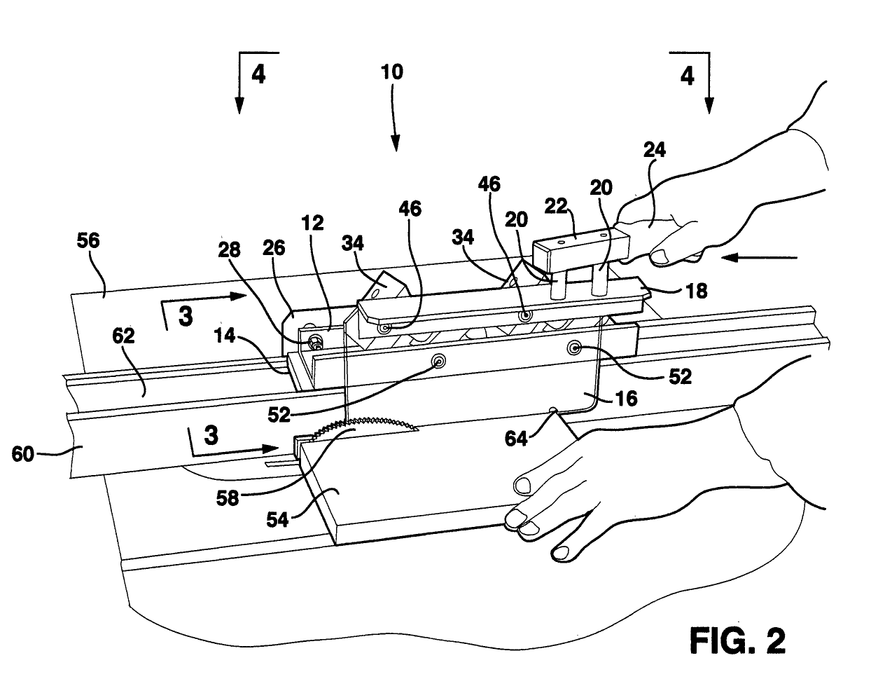

FIG. 2 is a perspective view of the push guide 10, in use, in the forward cutting position on a table saw 56. An important feature of the invention is handle 22 which has a grip 24 for operators comfort and ease of use. Two handle riser supports 20 connect handle 22 to handle support member 18. Support member 18 has a specially configured slot to accommodate vertical guide plate 16. Plate 16 is made of polycarbonate sheet such as Lexan. This assembly of components comprise the work unit part of device 10 which moves in a small forward arc, about points located at pivot bolts 46 and spring pivot bolts 52, when activated.

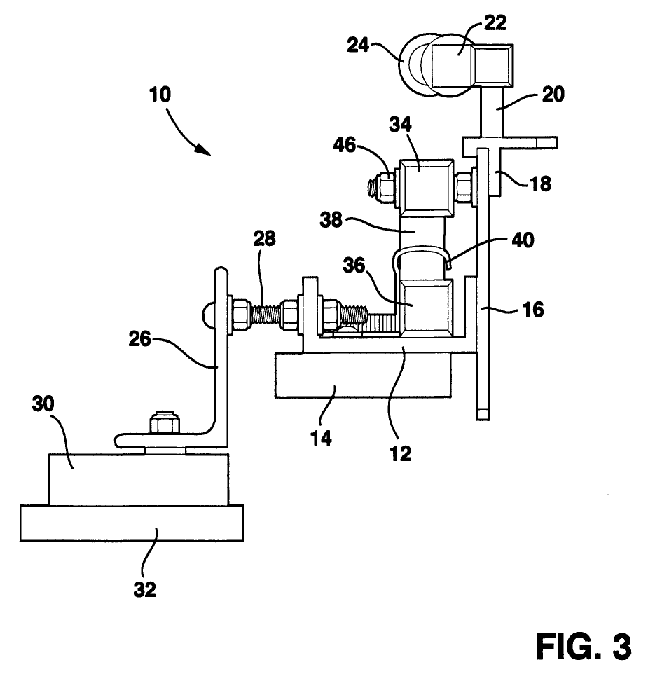

FIG. 3 is a side view of the forward end of the push guide 10. This view shows 6061 aluminum pivot rod 38 connected to upper pivot block 34 and lower pivot block 36. Block 34 and block 36 are made of UHMW polyethylene. There are two of these assemblies. Blocks 34 are connected to the work unit, part of the device, by pivot bolts 46. Blocks 36 are connected to the channel 12 by spring pivot bolts 52. A pair of pivot springs 40 function as a tensioning element between the channel 12 and the pivot rods 38. In the rest position, pivot bumpers 42 are in contact with channel 12. Bumpers 42 are permanently attached to blocks 36. Their use is to tilt the rods 38 at an angle of approximately 75 degrees relative to channel 12 when at rest.

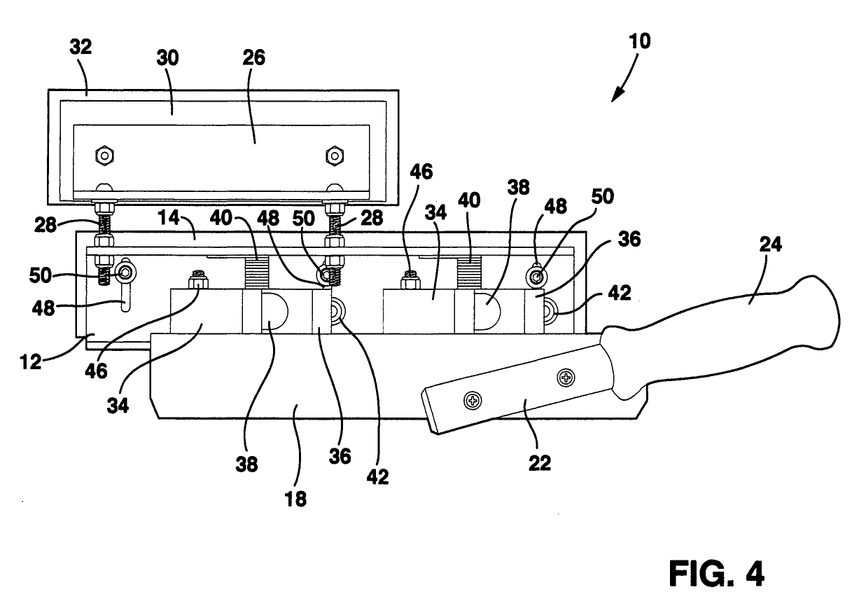

FIG. 4 is a plan view of the push guide. When pushed in a forward direction device 10 slides forward in slot 62. As vertical guide plate 16 travels through its range of motion, due to force from the operator, it engages stock material 54 at 90 degree notch 64. Thus moving the material 54 into contact with saw blade 58. Continuous motion by the operator completes the cut.

While the above description contains many specificties, these should not be construed as limitations on the scope of the invention, but rather as an exemplification of one preferred embodiment thereof. Many other variations are possible such as additional numbers of pivots, plates, glides, automation, other proportional and dimensional configurations, various use of materials in construction, pluralities of work pieces, handles, grips and use on all types of processing equipment.

Accordingly, the scope of the invention should be determined not by the embodiments illustrated, but by the appended claims and their legal equivalents.

### REFERENCE NUMERALS

10 Push Guide Device
12 Channel
14 Base Plate Glide
16 Vertical Guide Plate
18 Handle Support Member
20 Handle Riser Supports
22 Handle
24 Grip
26 Side Angle
28 Side Bolts
30 Ballast Bar
32 Table Plate Guide
34 Upper Pivot Block
36 Lower Pivot Block
38 Pivot Block
40 Pivot Spring
42 Pivot Bumper
44 Side Angle Adjustment Slot
46 Pivot Bolt
48 Channel Adjustment Slot
50 Channel Adjustment Bolt
52 Spring Pivot Bolt
54 Stock Material
56 Table Saw
58 Saw Blade
60 Table Saw Fence
62 Fence Slot
64 Notch

I claim:

1. A push guide device for stock material cutting on a table saw, comprising:
a. a holding apparatus for the stock material.

2. A holding apparatus for stock material cutting on a table saw, comprising:
a. a dual plate glide arrangement,
b. a handle.
c. a vertical guide plate.
d. means for holding a stock material work piece,
whereby said plates can be moved along a fence slot of a table saw fence.

3. The push guide device for stock material cutting of claim 2 comprising:
a. a holding apparatus and work piece engaged to a table saw, and
b. a holding means allowing stock material to be cut.
c. a holding means allowing a work piece 0.25 inches of thickness to be processed.

4. The push guide device for stock material cutting of claim 2 comprising:
a. a holding apparatus and engaged to a table saw with a cutting blade.
b. a direct means to modify the use of a table saw fence.
c. a direct means to eliminate short work piece gauging and chipping safely.

5. The holding apparatus of claim 2 comprising:
a. base plate glides and
b. slippery bottom surfaces.
c. top surfaces supporting a plurality of utilities.
d. a movable vertical guide plate.

6. The clamping apparatus of claim 2 comprising:
a. a push handle and
b. comfort means for the operator.

7. The holding apparatus of claim 2 comprising:
a. a vertical guide plate and
b. squaring means to the saw blade.
c. a pivot rod assembly activated by the operator.
d. an unobstructed view of the cut in progress.
e. a handle preventing operators hands from contacting saw blade.

8. The holding apparatus of claim 2 comprising:
a. a adjustable means to hold stock material.
b. a means for precision cutting of a work piece.
c. a means for holding a variety of sizes of stock material.
